(19) United States
(12) Patent Application Publication
(10) Pub. No.: US 2016/0379317 A1
(43) Pub. Date: Dec. 29, 2016

(54) HARVEST AMOUNT DISPLAY METHOD, CONVERSION METHOD, RECORDING MEDIUM, AND SYSTEM

(71) Applicant: FUJITSU LIMITED, Kawasaki-shi (JP)

(72) Inventor: Makoto HONDA, Odawara (JP)

(73) Assignee: FUJITSU LIMITED, Kawasaki-shi (JP)

(21) Appl. No.: 15/259,225

(22) Filed: Sep. 8, 2016

Related U.S. Application Data
(63) Continuation of application No. PCT/JP2014/056689, filed on Mar. 13, 2014.

(51) Int. Cl. G06Q 50/02; G06Q 10/08

(52) U.S. Cl. CPC G06Q 50/02; G06Q 10/087

(57) ABSTRACT

A harvest amount display method executed by a computer includes receiving input of a value indicating a harvest amount of a predetermined crop by a unit of storage; converting, by the computer, the input first value into a value indicating a corresponding weight; displaying the first value and the value indicating the weight, obtained by conversion; and changing, when among displayed values, the first value is changed, the value indicating the weight to a value indicating a weight corresponding to the changed value indicating the harvest amount by a unit of storage, and refraining from changing the input first value, when among the displayed values, the value indicating the weight is changed.

### CROSS REFERENCE TO RELATED APPLICATIONS

This application is a continuation application of International Application PCT/JP2014/056689, filed on Mar. 13, 2014 and designating the U.S., the entire contents of which are incorporated herein by reference.

### FIELD

The embodiments discussed herein are related to a harvest amount display method, a conversion method, a recording medium, and a system.

### BACKGROUND

In harvesting operations of a crop, a worker working in a field, may put the harvested crop a designated box or bag and register the harvest amount of the harvested crop by the number of boxes or bags into which harvested crop was put, without paying attention to the weight of the harvested crop. The harvest amount registered by the number of containers or boxes, for example, is used in evaluating the work performance of the worker performing the harvesting operations.

On the other hand, when evaluating the harvest amount and yield, evaluation by weight such as kilograms (kg) and the like is frequently used. Therefore, to know the weight of the harvested crop, for example, the number of containers or boxes registered by a worker may be converted into a corresponding weight by a predetermined conversion ratio.

According to a related prior art, for example, quantities indicated in purchase data and sales data for products handled by differing product codes and quantity units are converted to quantities of the smallest basic unit for the product codes used in inventory management, whereby inventory information is updated. For example, refer to Japanese Laid-Open Patent Publication No. H11-203562.

### SUMMARY

According to an aspect of an embodiment, a harvest amount display method includes receiving, by a computer, input of a value indicating a harvest amount of a predetermined crop by a unit of storage; converting, by the computer, the input first value into a value indicating a corresponding weight; displaying, by the computer, the first value and the value indicating the weight, obtained by conversion; and changing, by the computer and when among displayed values, the first value is changed, the value indicating the weight to a value indicating a weight corresponding to the changed value indicating the harvest amount by a unit of storage, and refraining, by the computer, from changing the input first value, when among the displayed values, the value indicating the weight is changed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting an example of a harvest amount display method according to an embodiment;

FIG. 2 is a diagram depicting an example of system configuration of a system 200;

FIG. 3 is a block diagram of an example of hardware configuration of a harvest amount display apparatus 100;

FIG. 4 is a block diagram of an example of hardware configuration of a client apparatus 201;

FIG. 5 is a diagram depicting an example of contents of a production plan DB 220;

FIG. 6 is a diagram depicting an example of contents of a units-of-storage master 230;

FIG. 7 is a diagram depicting an example of contents recorded in a harvest amount table 240;

FIG. 8 is a diagram depicting an example of a units-of-storage master maintenance screen;

FIG. 9 is a diagram depicting an example of a production plan registration screen;

FIG. 10 is a diagram depicting an example of a harvest amount registration screen;

FIG. 11 is a block diagram of an example of a functional configuration of the harvest amount display apparatus 100;

FIG. 12 is a diagram of a screen change example of the harvest amount registration screen 1000;

FIG. 13 is a diagram of a screen change example of the harvest amount registration screen 1000;

FIGS. 14 and 15 are flowcharts of a procedure of a harvest amount display process of the harvest amount display apparatus 100; and

FIG. 16 is a flowchart of an example of details of a process procedure of a conversion ratio identifying process.

### DESCRIPTION OF THE INVENTION

Embodiments of a harvest amount display method, a conversion method, a harvest amount display program, a conversion program, and a system will be described in detail with reference to the accompanying drawings.

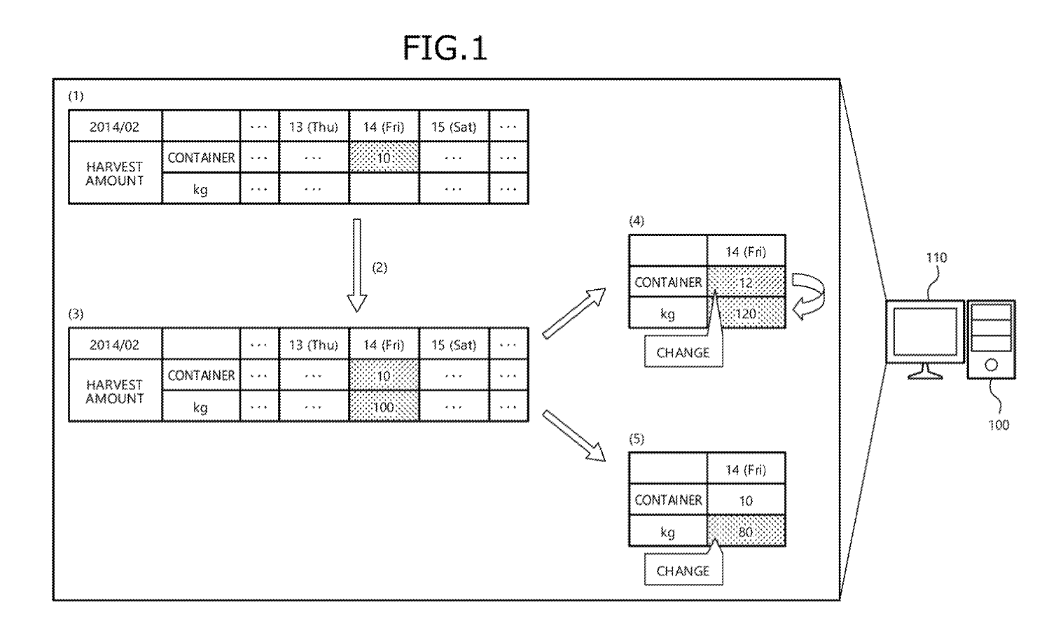

FIG. 1 is a diagram depicting an example of the harvest amount display method according to an embodiment. In FIG. 1, a harvest amount display apparatus 100 is a computer configured to display a harvest amount of a crop by a unit of weight and a unit of storage. A crop is a product produced by agriculture such as, for example, grains, vegetables, fruits, flowers, and ornamental plants. A harvest amount is a harvest of a crop, that is, the amount of a harvested crop.

A unit of weight is a unit by which the weight of a harvested crop is measured. A unit of weight, for example, may be kilograms (kg), tons (t), or pounds (lb). A unit of storage is a unit by which the amount of a harvested crop is measured such as, for example, a unit by which a harvested crop may be counted such as a bundle of the harvested crop or a receptacle into which the harvested crop is put and used in the harvesting operations. A receptacle into which harvested crop is put, for example, may be a container, a box, a case, and the like.

In the harvesting operation of a crop, a worker may register the harvest amount of a harvested crop by a unit of storage without paying attention to the weight of the harvested crop. Harvest amounts registered by a unit of storage, for example, are used in evaluating the work performance of a worker performing harvesting operations. For example, when containers are used in the harvesting operations, the harvest amount is registered as a container count and from the container count, work performance is evaluated.

On the other hand, when evaluating the harvest amount and yield, evaluation by weight such as kg and the like is frequently used. Here, the yield is the harvest of a crop per unit of farmland. The unit of farmland may be expressed, for example, as 10 are (a). Therefore, to evaluate the harvest amount and yield of a crop, the harvest amount registered by a unit of storage is converted to a harvest amount in a unit of weight by a predetermined conversion rate.

Nonetheless, the weight of the harvested crop that will fit in a single receptacle such as a container or box varies according to how the worker puts the crop in the receptacle, the specific gravity of the crop dependent on season, and the like. Therefore, the correct weight of the harvested crop put in a single receptacle such as a container or box may is frequently not known without actually measuring the weight such as at the time of sorting, shipping, etc.

Accordingly, the harvest amount in a unit of weight obtained by converting the harvest amount in a unit of storage using a predetermined conversion rate may be corrected at the time of sorting, shipping, and the like. In this case, the harvest amount in a unit of storage registered by a worker changes corresponding to the correction of the harvest amount in a unit of weight and there may be cases where the work performance of the worker cannot be correctly evaluated.

Thus, in the present embodiment, a harvest amount display method will be described that enables identification of the harvest amount of a crop by a unit of weight without actually measuring the weight of harvested crop and that prevents the harvest amount in a unit of storage for evaluating the work performance of a worker from being changed corresponding to a correction of the weight performed at the time of shipping, etc. Hereinafter, an example of harvest amount display by the harvest amount display apparatus 100 will be described.

(1) The harvest amount display apparatus 100 receives input of a value indicating the harvest amount of a certain crop in a unit of storage. In the example depicted in FIG. 1, on 2014 Feb. 14 (Fri.), harvesting operations of the certain crop using a container were performed and a container count “10” is input as a value indicating the harvest amount for that date in a unit of storage.

(2) The harvest amount display apparatus 100 converts the input value indicating the harvest amount in a unit of storage into a value indicating a corresponding weight. Here, the value indicating the weight of the harvest amount is a value indicating the harvest amount by a unit of weight. For example, the harvest amount display apparatus 100 uses a predetermined conversion ratio and converts the input value indicating the harvest amount by a unit of storage into a value indicating the harvest amount by a unit of weight.

Although detailed description will be given later, the predetermined conversion ratio used when the input value indicating the harvest amount by a unit of storage is converted, for example, is identified by a category, a cropping model, a harvest date, a planned harvest period, etc. of the crop. Here, the unit of storage is assumed to be “container”, the unit of weight is assumed to be “kg”, and the conversion ratio of “container” and “kg” is assumed to be “1:10”.

In this case, the harvest amount display apparatus 100 converts by the conversion ratio “1:10”, the input value “10” indicating the harvest amount by a unit of storage into a value “100” indicating the harvest value by a unit of weight. In the description hereinafter, a value indicating the weight of the harvest amount, i.e., a value indicating the harvest amount by a unit of weight may be indicated as simply “weight value”.

(3) The harvest amount display apparatus 100 displays on a display 110, the input value indicating the harvest amount by a unit of storage and the weight value obtained by conversion. In the example depicted in FIG. 1, the input value “10” indicating the harvest amount by a unit of storage and the weight value “100” obtained by conversion are displayed. The display 110 may be that of the harvest amount display apparatus 100 or may be that of another computer.

(4) When among the displayed values, the value indicating the harvest amount by a unit of storage is changed, the harvest amount display apparatus 100 changes the weight value to a weight value corresponding to the changed value indicating the harvest amount by a unit of storage. Here, the value indicating the harvest amount by a unit of storage is assumed to be errantly input and a correct value “12” indicating the harvest amount by a unit of storage is assumed to be re-input.

In this case, the harvest amount display apparatus 100 converts, by the conversion ratio “1:10”, the re-input value “12” indicating the harvest amount by a unit of storage into a weight value “120”. The harvest amount display apparatus 100 changes the weight value displayed on the display 110 from “100” to “120”.

(5) When among the displayed values, the weight value is changed, the harvest amount display apparatus 100 does not change the input value indicating the harvest amount by a unit of storage. Here, at the time of shipping, the actual measured weight of the harvested crop is assumed to be 80 kg and the weight value obtained by conversion is assumed to be changed to “80”.

In this case, the harvest amount display apparatus 100 changes the weight value displayed on the display 110 from “100” to “80”. Here, the harvest amount display apparatus 100 does not change the displayed value indicating the harvest amount by a unit of storage corresponding to the change of the weight value. In other words, if the harvest amount in a unit of storage is changed, the work performance of the worker cannot be correctly evaluated and therefore, the harvest amount display apparatus 100 does not change the value indicating the harvest amount by a unit of storage.

In this manner, the harvest amount display apparatus 100 enables input of a value indicating the harvest amount of a crop by a unit of storage to be received; the input value indicating the harvest amount by a unit of storage to be converted into a corresponding weight value; and the input value indicating the harvest amount by a unit of storage and the weight value obtained by conversion to be displayed. As a result, without actually measuring the weight of the harvested crop, the harvest amount of the crop may be identified by a unit of weight such as kg and the harvest amount, yield, etc. may be evaluated.

The harvest amount display apparatus 100 enables the weight value to be changed to a weight value corresponding to a changed value indicating the harvest amount by a unit of storage, when among the displayed values, the value indicating the harvest amount by a unit of storage is changed; and enables the input value indicating the harvest amount by a unit of storage to not be changed, when the weight value is changed. As a result, when the weight of the harvest amount is corrected at the time of sorting, shipping, etc., a count of containers, boxes, etc. for evaluating the work performance of a worker may be prevented from being changed corresponding to the correction of the weight.

A case where the harvest amount display apparatus 100 depicted in FIG. 1 is applied to a system 200 will be described.

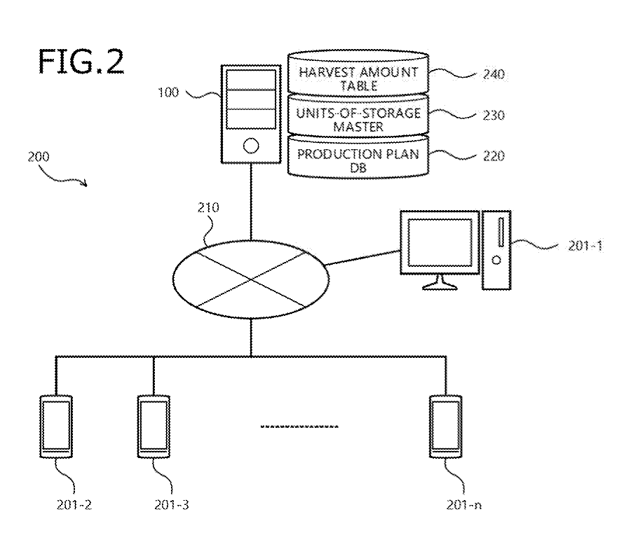

FIG. 2 is a diagram depicting an example of system configuration of the system 200. In FIG. 2, the system 200 is configured by the harvest amount display apparatus 100 and client apparatuses 201-1 to 201-n (n is a natural number of 2 or more). In the system 200, the harvest amount display apparatus 100 and the client apparatuses 201-1 to 201-n are connected through a network 210 that may be wired or wireless. The network 210, for example, is a local area network (LAN), a wide area network (WAN), or the Internet.

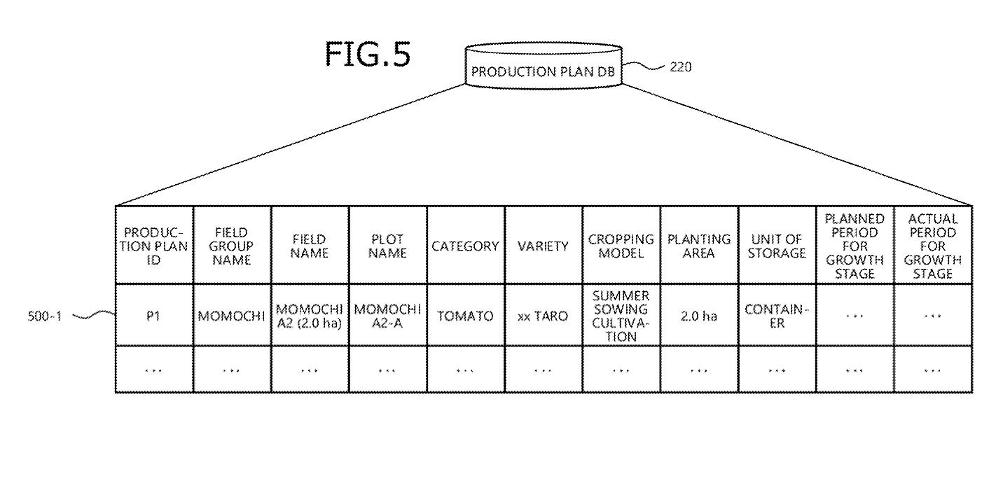

Here, the harvest amount display apparatus 100 has a production plan database (DB) 220, a units-of-storage master 230, and a harvest amount table 240, and performs display control of the client apparatuses 201-1 to 201-n. The harvest amount display apparatus 100, for example, is a server. Contents stored in the various DBs 220, 230, and 240 will be described with reference to FIGS. 5 to 7.

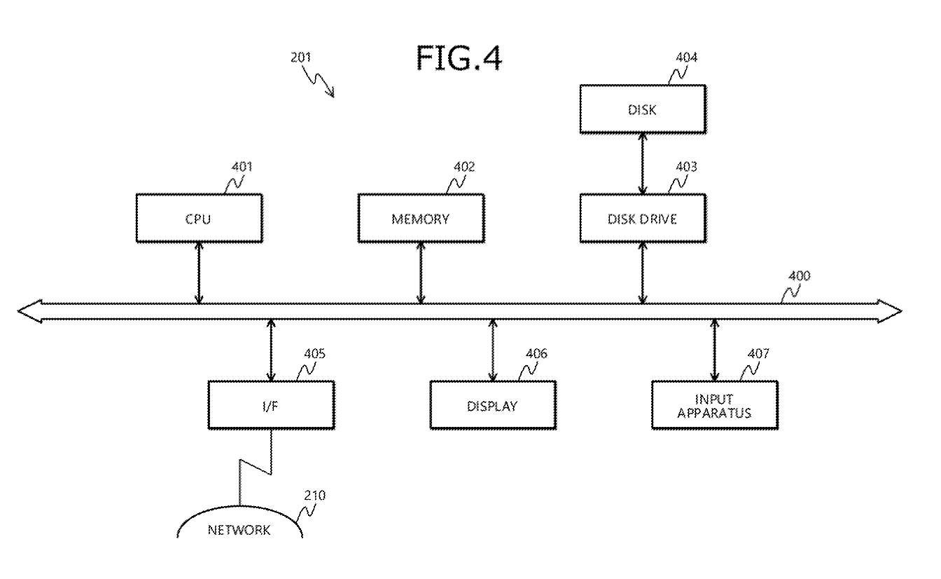

The client apparatuses 201-1 to 201-n have a display (for example, a display 406 depicted in FIG. 4 and described hereinafter) and are computers configured to display various screens under the display control of the harvest amount display apparatus 100. The client apparatuses 201-1 to 201-n, for example, are personal computers (PCs), note PCs, tablet PCs, smartphones, and the like used by the farm manager or workers involved in agricultural operations.

The various screens include, for example, a units-of-storage master maintenance screen, a production plan registration screen, and a harvest amount registration screen. A units-of-storage master maintenance screen is a screen for registering a conversion ratio of units of weight and units of storage for a crop. The production plan registration screen is a screen for registering a production plan for a crop. The harvest amount registration screen is a screen for registering the harvest amount of a crop.

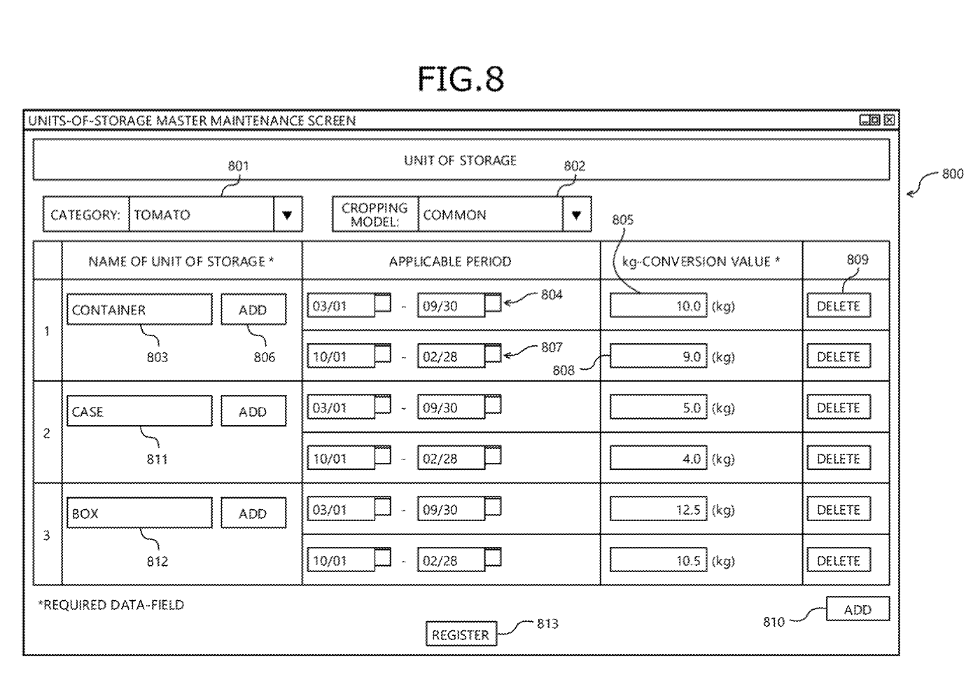

For example, the harvest amount display apparatus 100, when receiving a display request for various screens from the client apparatuses 201-1 to 201-n, generates screen information for the various screens and transmits the generated screen information to the client apparatuses 201-1 to 201-n. As a result, the various screens are displayed on the displays of the client apparatuses 201-1 to 201-n. An example of the various screens will be described with reference to FIGS. 8 to 10.

In the description hereinafter, the client apparatuses 201-1 to 201-n may be indicated as simply “client apparatus 201”.

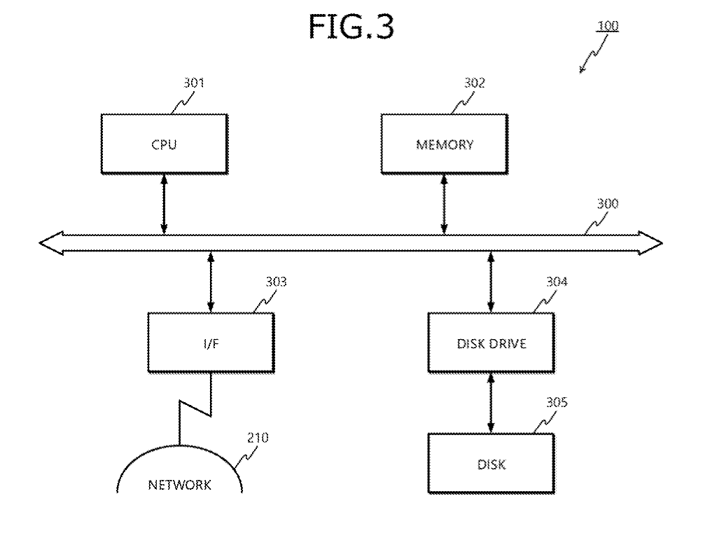

FIG. 3 is a block diagram of an example of hardware configuration of the harvest amount display apparatus 100. In FIG. 3, the harvest amount display apparatus 100 has a central processing unit (CPU) 301, memory 302, an interface (I/F) 303, a disk drive 304, and a disk 305. Respective components are connected by a bus 300.

Here, the CPU 301 governs overall control of the harvest amount display apparatus 100. The memory 302, for example, includes read-only memory, (ROM), random access memory (RAM), and flash ROM. In particular, for example, the flash ROM and ROM record various types of programs, and the RAM is used as a work area of the CPU 301. A program recorded in the memory 302 is loaded onto the CPU 301, whereby coded processes are executed by the CPU 301.

The I/F 303 is connected to the network 210 through a communications line and is connected other computers (for example, the client apparatus 201 depicted in FIG. 2) via the network 210. The I/F 303 administers an internal interface with the network 210 and controls the input and output of data from other computers. The I/F 303, for example, may be a modem, a LAN adapter, or the like.

The disk drive 304, under the control of the CPU 301, controls the reading and writing of data with respect to the disk 305. The disk 305 records data written thereto under the control of the disk drive 304. The disk 305, for example, may be a magnetic disk, an optical disk, and the like.

In addition to the components described, the harvest amount display apparatus 100 may further have, for example, a solid state drive (SSD), a keyboard, a mouse, a display, and the like.

FIG. 4 is a block diagram of an example of hardware configuration of the client apparatus 201. In FIG. 4, the client apparatus 201 has a CPU 401, memory 402, a disk drive 403, a disk 404, an I/F 405, the display 406, and an input apparatus 407. Respective components are connected by a bus 400.

Here, the CPU 401 governs overall control of the client apparatus 201. The memory 402, for example, includes ROM, RAM, and flash ROM. In particular, for example, the flash ROM and ROM record various types of programs, and the RAM is used as a work area of the CPU 401. A program recorded in the memory 402 is loaded onto the CPU 401, whereby a coded process is executed by the CPU 401.

The disk drive 403, under the control of the CPU 401, controls the reading and writing of data with respect to the disk 404. The disk 404 records data written thereto under the control of the disk drive 403. The disk 404, for example, may be a magnetic disk, an optical disk, and the like.

The I/F 405 is connected to the network 210 through a communications line and is connected to other computers (for example, the harvest amount display apparatus 100) via the network 210. The I/F 405 administers an internal interface with the network 210 and controls the input and output of data from other computers.

The display 406 displays data such as documents, images, and functional information, in addition to a cursor, icons, and toolboxes. The display 406, for example, may be a cathode ray tube (CRT) display, a liquid crystal display, an organic electroluminescence (EL) display, and the like. The display 406 corresponds to the display 110 depicted in FIG. 1.

The input apparatus 407 has keys for inputting text, numbers, various instructions, and the like, and performs data input. The input apparatus 407 may be a keyboard or a mouse, or may be a touch panel-type input pad or numeric pad.

Among the components above, the client apparatus 201 may omit, for example, the disk drive 403, the disk 404, and the like. Further, the client apparatus 201 may be configured to have, for example, a SSD, a scanner, a printer, and the like in addition to the components above.

Contents of the various DBs 220, 230, and 240 will be described with reference to FIGS. 5 to 7. The various DBs 220, 230, and 240, for example, are realized by the memory 302 and the disk 305 of the harvest amount display apparatus 100 depicted in FIG. 3.

FIG. 5 is a diagram depicting an example of the contents of the production plan DB 220. In FIG. 5, the production plan DB 220 has data-fields for production plan IDs, field group names, field names, plot names, categories, varieties, cropping models, planting areas, units of storage, planned period for a growth stage, and actual period for a growth stage. Information is set into the data-fields, whereby production plan information (for example, production plan information 500-1) is stored as records.

Here, a production plan ID is an identifier identifying a production plan. A production plan is a plan indicating in which field and how much of a crop that is to be produced is to be planted. A field is farmland, cropland, etc. for cultivating and growing crops. A field group name is the name of a group to which collectively managed fields belong. A field name is the name of a field. A plot name is the name of a section into which a field is segmented and divided.

A category is the type of a crop such as, for example, tomato, paddy rice, cabbage, etc. A variety is a type within a single category. For example, among varieties of cabbage are autumn-winter cabbage, winter cabbage, spring cabbage, etc. A cropping model is a system of a combination of techniques and conditions for cultivating a crop, such as, for example, direct seeding, transplanting, spring sowing cultivation, summer sowing cultivation, autumn sowing cultivation, winter sowing cultivation, and the like.

A planting area is the area (amount of land) for planting a crop. A unit of storage is a unit by which a harvested crop may be counted such as a bundle of the harvested crop or a receptacle into which the harvested crop is put and used in the harvesting operations. For example, a harvested crop may be counted in units of containers, boxes, cases, bundles, pieces, etc. A planned period for a growth stage is a planned period for each growth stage of a crop. An actual period for a growth stage is an actual period for each growth stage of a crop.

A growth stage indicates a growth phase of a crop. For example, growth stages of tomatoes include a seeding phase, a seedling growth phase, a planting phase, a growth phase, a flowering phase, a fruit growth phase, a harvest phase, etc. Although not depicted, other than the information described above, the production plan DB 220 may further record, for example, cultivation guidelines, planned cultivation start dates, planned cultivation end dates, cultivation periods, harvest amounts, selling unit price, amount of sales, etc. for a plan.

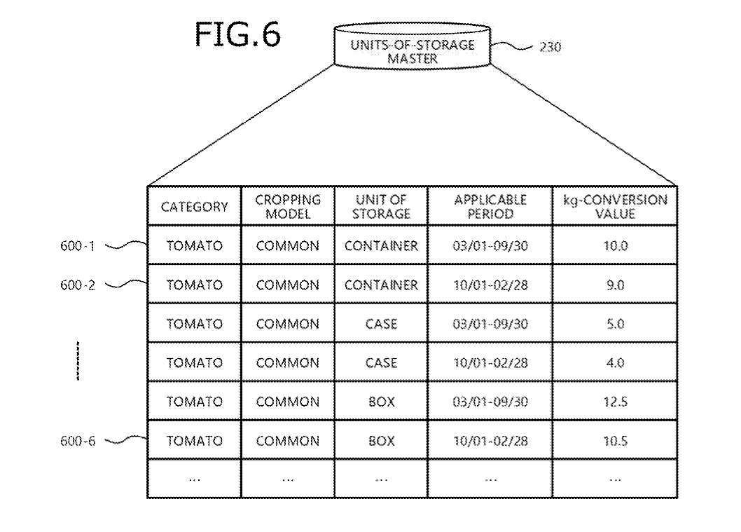

FIG. 6 is a diagram depicting an example of the contents of the units-of-storage master 230. In FIG. 6, the units-of-storage master 230 has data-fields for categories, cropping models, units of storage, applicable periods, and kg-conversion values. Information is set into the data-fields, whereby unit-of-storage information (for example, unit-of-storage information 600-1 to 600-6) is recorded as records.

Here, a category is a type of a crop. A cropping model is a system of a combination of techniques and conditions for cultivating a crop. A unit of storage is a unit by which a harvested crop may be counted such as a bundle of the harvested crop or a receptacle into which the harvested crop is put and used in the harvesting operations. An applicable period is a period to which a conversion ratio indicating a kg-conversion value is applicable. A kg-conversion value is a conversion ratio applied when a value indicating a harvest amount in a unit of storage is converted into kilograms, a unit of weight.

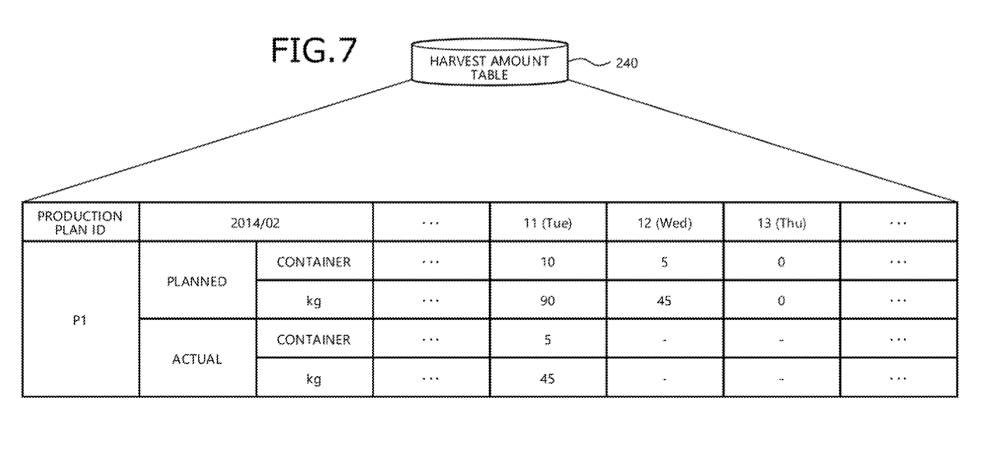

FIG. 7 is a diagram depicting an example of the contents recorded in the harvest amount table 240. In FIG. 7, the harvest amount table 240 records planned daily harvest amounts and actual harvest amounts concerning crops for which a production plan identified by a production plan ID has been created. A planned harvest amount is a harvest amount planned to be harvested. An actual harvest amount is a harvest amount actually harvested.

In the harvest amount table 240, as planned harvest amounts, planned harvest amounts indicated in units of containers (a unit of storage) and planned harvest amounts indicated in units of kg (a unit of weight) are recorded. Further, in the harvest amount table 240, as actual harvest amounts, actual harvest amounts indicated in units of containers (a unit of storage) and actual harvest amounts indicated in units of kg (a unit of weight) are recorded.

In the example depicted in FIG. 7, in the harvest amount table 240, concerning a crop for which a production plan identified by a production plan ID “P1” has been created, planned daily harvest amounts for 2014 February and actual daily harvest amounts until 2014 Feb. 11 are recorded.

FIG. 8 is a diagram depicting an example of a units-of-storage master maintenance screen. In FIG. 8, a units-of-storage master maintenance screen 800 is a screen for registering for a crop, a conversion ratio for a unit of storage and a unit of weight. A units-of-storage master maintenance screen 800 is displayed on the display 406 of the client apparatus 201.

In a units-of-storage master maintenance screen 800, for example, the category of a crop may input when a user operates the input apparatus 407 of the client apparatus 201 depicted in FIG. 4 and clicks a box 801. In this example, the category “tomato” is input.

Further, the cropping model of a crop may be input when a box 802 is clicked. In this example, the cropping model “common” is input. Cropping model “common” means “common to all cropping models”. Further, a name of the unit of storage for a crop may be input when a box 803 is clicked. In this example, a name of the unit of storage “container” is input.

An applicable period in which a conversion ratio indicating a kg-conversion value is applicable may be input when a box 804 is clicked. In this example, an applicable period “March 1-September 30” is input. A kg-conversion value may be input when a box 805 is clicked. In this example, a kg-conversion value “10.0” is input.

Boxes for inputting an applicable period and a kg-conversion value may be added when an add button 806 is clicked. In this example, a box 807 for inputting an applicable period and a box 808 for inputting a kg-conversion value are added. Further, an applicable period “October 1-February 28” is input to the box 807 and a kg-conversion value “9.0” is input to the box 808.

The boxes 804, 805 may be deleted when a delete button 809 is clicked. Further, a box for inputting the name of the unit of storage may be added by clicking an add button 810. In this example, boxes 811, 812 for inputting a name of the unit of storage are added.

The various types of information input to the units-of-storage master maintenance screen 800 are transmitted from the client apparatus 201 to the harvest amount display apparatus 100 when a register button 813 is clicked. As a result, unit-of-storage information based on the various types of information input to the units-of-storage master maintenance screen 800 is recorded to the units-of-storage master 230.

Thus, the units-of-storage master maintenance screen 800 enables a conversion ratio of a unit of storage and a unit of weight for a crop to be registered to the units-of-storage master 230 by an input of the category, the cropping model, the unit of storage, the applicable period, and the kg-conversion value. In the example depicted in FIG. 8, the unit-of-storage information 600-1 to 600-6 depicted in FIG. 6 is recorded to the units-of-storage master 230.

In the description above, although an applicable period in which a conversion ratio indicating a kg-conversion value is applicable is input, configuration is not limited hereto. For example, input of an applicable period may be omitted by the user inputting a name of the unit of storage reflecting an applicable period in which a conversion ratio indicating a kg-conversion value is applicable.

For example, when a container used in harvesting operations during an applicable period “March 1-September 30” is called “summer container”, the user may input to the box 803, “summer container” as the name of the unit of storage reflecting the applicable period “March 1-September 30”.

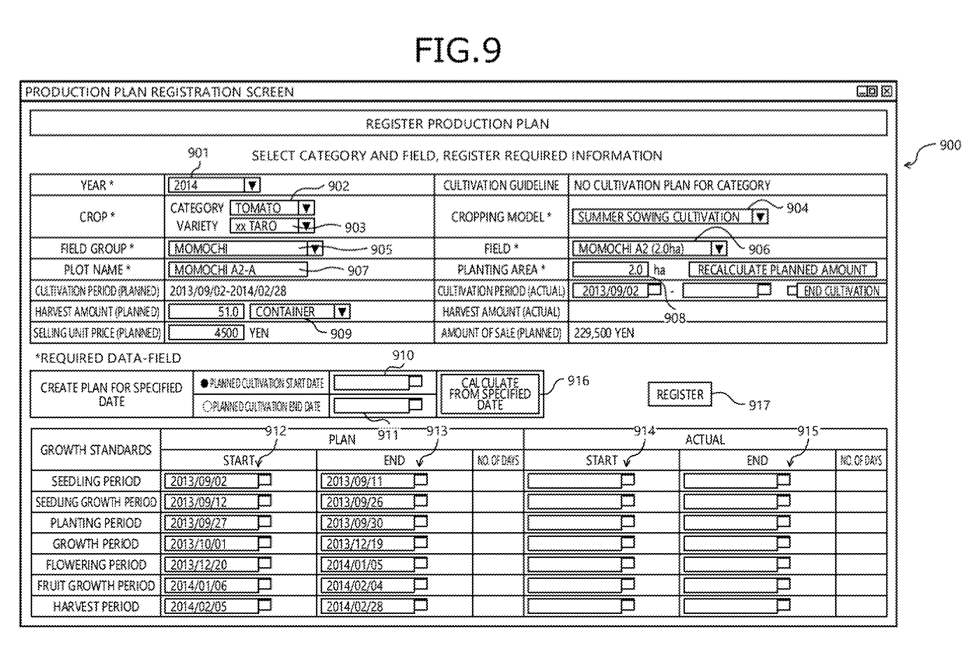

FIG. 9 is a diagram depicting an example of the production plan registration screen. In FIG. 9, a production plan registration screen 900 is a screen for registering a production plan for a crop. The production plan registration screen 900 is displayed on the display 406 of the client apparatus 201.

In the production plan registration screen 900, for example, the year for which a production plan is created may be input when a box 901 is clicked. In this example, a year “2014” is input. The category of a crop may be input when a box 902 is clicked. In this example, the category “tomato” is input.

The variety of the crop may be input when a box 903 is clicked. In this example, the variety “xx Taro” is input. A cropping model of the crop may be input when a box 904 is clicked. In this example, a cropping model “summer sowing cultivation” is input. A field group to which a field in which the crop is to be planted belongs may be input when a box 905 is clicked. In this example, the field group “momochi” is input.

A field in which the crop is to be planted may be input when a box 906 is clicked. In this example, a field “momochi A2 (2.0 ha)” is input. A plot name in the field in which the crop is to be planted may be input when a box 907 is clicked. In this example, a plot name “momochi A2-A” is input.

A planting area (amount of land) for planting the crop may be input when a box 908 is clicked. In this example, a planting area “2.0” is input. A name of the unit of storage of the crop may be input when a box 909 is clicked. The unit of storage of the crop, for example, is determined with consideration of the category of the crop, the planting area for the crop, etc. In this example, the name of the unit of storage “container” is input.

A planned cultivation start date for the crop may be input when a box 910 is clicked. A planned cultivation end date for the crop may be input when a box 911 is clicked. A start date for a planned period for a growth stage of the crop may be input when a box 912 is clicked.

An end date of a planned period for a growth stage for the crop may be input when a box 913 is clicked. In this example, respective start and end dates of a seedling period, a seedling growth period, a planting period, a growth period, a flowering period, a fruit growth period, and a harvest period are input as planned periods for growth stages of the crop.

The start date of the actual period for a growth stage may be input when a box 914 is clicked. The end date of the actual period for a growth stage may be input when a box 915 is clicked. When a button 916 is clicked, reference planned periods for growth stages of the crop are automatically calculated based on the planned cultivation start date or the planned cultivation end date, and start and end dates are input to boxes 912, 913.

The various types of information input to the production plan registration screen 900 are transmitted from the client apparatus 201 to the harvest amount display apparatus 100, when a register button 917 is clicked. As a result, production plan information based on the various types of information input to the production plan registration screen 900 are recorded to the production plan DB 220.

In this manner, the production plan registration screen 900 enables a production plan for a crop to be registered to the production plan DB 220 by an input of various types of information concerning the crop planned for cultivation. In the example depicted in FIG. 9, the production plan information 500-1 depicted in FIG. 5 is recorded to the production plan DB 220.

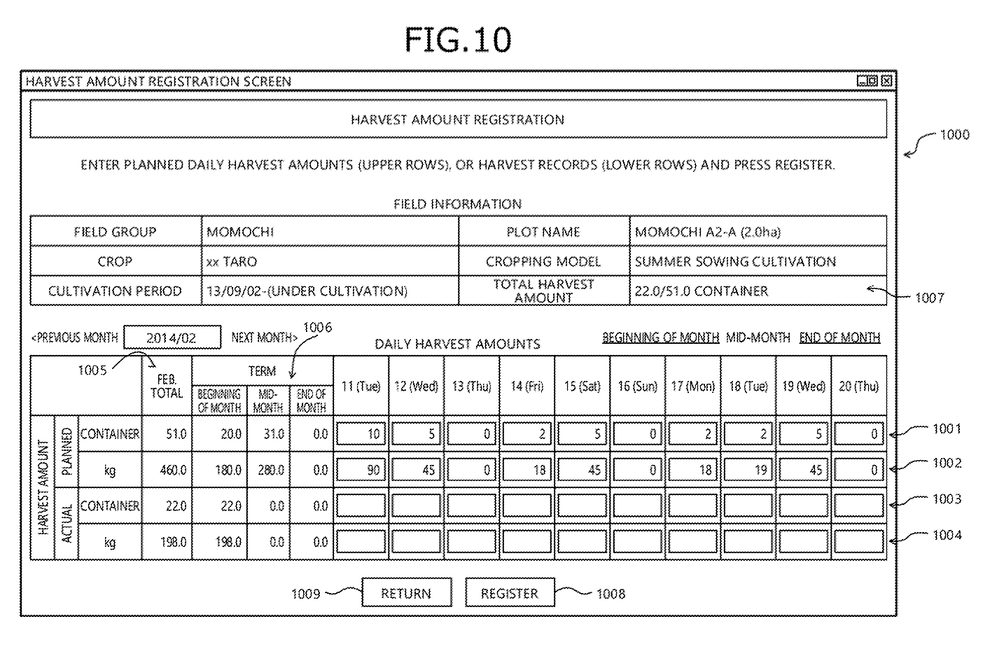

FIG. 10 is a diagram depicting an example of a harvest amount registration screen. In FIG. 10, a harvest amount registration screen 1000 is a screen for registering the harvest amount of a crop. The harvest amount registration screen 1000 is displayed on the display 406 of the client apparatus 201.

For example, the user of the client apparatus 201, selects from a field list screen (not depicted), a field of a crop for which a harvest amount is to be registered. The client apparatus 201 transmits to the harvest amount display apparatus 100, a display request for a harvest amount registration screen that includes the field group name, the field name, the plot name, etc. of the selected field.

The harvest amount display apparatus 100 obtains from the production plan DB 220, production plan information corresponding to the field group name, the field name, and the plot name included in the received display request for a harvest amount registration screen. The harvest amount display apparatus 100 refers to the harvest amount table 240 corresponding to the production plan ID of the obtained production plan information and generates screen information of a harvest amount registration screen.

The harvest amount display apparatus 100 transmits the generated screen information for the harvest amount registration screen to the client apparatus 201. As a result, the harvest amount registration screen 1000 is displayed on the display 406 of the client apparatus 201. Here, a case where a harvest amount concerning a crop for which a production plan identified by the production plan ID “P1” has been created will be described as an example.

In the harvest amount registration screen 1000, a planned harvest amount indicated in units of containers (a unit of storage) concerning a crop may be input for each day when a box 1001 is clicked by user input operation. In this example, planned daily harvest amounts for mid-February 2014 have been input in units of containers.

In the harvest amount registration screen 1000, a planned harvest amount indicated in units of kg (a unit of weight) may be input for a crop for each day when a box 1002 is clicked by user input operation. In this example, planned daily harvest amounts for mid-February 2014 have been input in units of kg.

Further, in the harvest amount registration screen 1000, the actual harvest amount indicated in units of containers (a unit of storage) may be input for a crop for each day when a box 1003 is clicked by user input operation. In this example, the actual harvest amounts indicated in units of containers for mid-February 2014 have not been input.

In the harvest amount registration screen 1000, the actual harvest amount indicated in units of kg (a unit of weight) may be input for a crop each day when a box 1004 is clicked by user input operation. In this example, the actual harvest amounts indicated in units of kg for mid-February 2014 have not been input.

In a box 1005, planned harvest amounts and the actual harvest amounts according to month are displayed in units of containers and units of weight. In box 1006, planned harvest amounts and the actual harvest amounts according to term (beginning of month, mid-month, end of month) in units of weight and units of containers are displayed.

In box 1007, the actual harvest amount with respect to the planned harvest amount for the month in units of containers is displayed as a total harvest amount. In the harvest amount registration screen 1000, each type of harvest amount is rounded to the nearest tenth. The various harvest amounts displayed in the harvest amount registration screen 1000 concern a worker who performed harvesting operations for the crop.

The various types of information input to the harvest amount registration screen 1000 are transmitted from the client apparatus 201 to the harvest amount display apparatus 100 when a button 1008 is clicked. As a result, the various harvest amounts input to the harvest amount registration screen 1000 are recorded to the harvest amount table 240.

In this manner, the harvest amount registration screen 1000 enables planned harvest amounts and the actual harvest amounts for a crop to be registered into the harvest amount table 240 by input of planned daily harvest amounts and the actual harvest amounts for a crop and indicated in a unit of storage and a unit of weight.

In the harvest amount registration screen 1000, a field list screen may again be displayed on the display 406 when a button 1009 is clicked, enabling reselection of a crop for which a harvest amount is to be registered. Further, the harvest amount registration screen 1000, for example, may be displayed on the display 406 by the user of the client apparatus 201 specifying a field group, a field, a plot name, a category, a variety, a cropping model, etc.

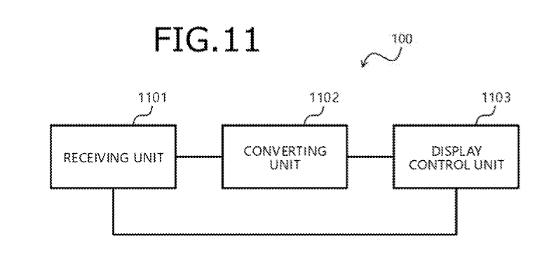

FIG. 11 is a block diagram of an example of a functional configuration of the harvest amount display apparatus 100. In FIG. 11, the harvest amount display apparatus 100 is configured by a receiving unit 1101, a converting unit 1102, and a display control unit 1103. The receiving unit 1101 to the display control unit 1103 are functions forming a control unit and, for example, are realized by executing on the CPU 301, a program recorded to a memory device such as the memory 302 and the disk 305 depicted in FIG. 3, or by the I/F 303. Process results of the functional units, for example, are recorded to a memory device such as the memory 302 and the disk 305.

Input of a value indicating the harvest amount by a unit of storage will be described. The receiving unit 1101 receives input of a value indicating the harvest amount of a certain crop by a unit of storage. The value indicating the harvest amount of the certain crop by a unit of storage, for example, is input to the harvest amount registration screen 1000 (refer to FIG. 10) by user input operation of the client apparatus 201. The user, for example, is a worker who performed harvesting operations for the crop.

The client apparatus 201 transmits to the harvest amount display apparatus 100, an input result of the input value indicating the harvest amount by a unit of storage. In this case, the receiving unit 1101 receives the input result from the client apparatus 201 and thereby, receives input of a value indicating the harvest amount of a certain crop by a unit of storage.

The converting unit 1102 converts the input value indicating the harvest amount by a unit of storage into a corresponding weight value. For example, the converting unit 1102 uses a predetermined conversion rule based on the crop and converts the input value indicating the harvest amount by a unit of storage into a corresponding weight value, i.e., converts the input value into a value indicating the harvest amount by a unit of weight.

Here, when the categories of crops differ, the shapes and the densities of the crops may differ and the weights of the crops fitting into a single container or box used in the harvesting operations may change. For example, the density of tomatoes is higher than the density of green peppers and the weight of tomatoes fitting into a single container or box is greater than that of green peppers.

Therefore, the converting unit 1102, for example, may use a conversion ratio for the category of the crop to convert the input value indicating the harvest amount by a unit of storage into a weight value. The conversion ratio is a ratio used when converting a value indicating the harvest amount by a unit of storage into a weight value. As a result, with consideration of shape and density, which vary consequent to the categories of crops differing, a value indicating the harvest amount by a unit of storage may be converted into a corresponding weight value.

Further, even when the categories of crops are the same, if the cropping model or harvesting period of the crops differ, the density of the crop may differ and the weight of the crop fitting into a single container or box may change. For example, the density of tomatoes is higher for tomatoes in the summer than in the winter.

Consequently, the weight of a single container or box of summer tomatoes is greater than that of winter tomatoes.

Therefore, the converting unit 1102, for example, may use a conversion ratio for the cropping model of the crop, a harvest date of the crop, or a planned harvest period of the crop to convert the input value indicating the harvest amount by a unit of storage into a weight value.

For example, the converting unit 1102 obtains production plan information of the crop from the production plan DB 220. The production plan information, for example, is information corresponding to the field group name, the field name, and the plot name of a field selected by the user of the client apparatus 201. A case where the production plan information 500-1 depicted in FIG. 5 is obtained is assumed as one example. In this case, the converting unit 1102 refers to the obtained production plan information 500-1 and identifies the category “tomato”, the cropping model “summer sowing cultivation” and the unit of storage “container” of the crop.

The converting unit 1102 refers to the obtained production plan information 500-1 and identifies a harvest period of a planned period for a growth stage or an actual period for a growth stage as a planned harvest period of the crop. Here, a harvest period “2014/02/05 to 2014/02/28” of a planned period for a growth stage is assumed to be identified as a planned harvest period of the crop.

The converting unit 1102 may identify as a harvest date of the crop, a date corresponding to an input column in which the value indicating the harvest amount by a unit of storage is input in the harvest amount registration screen 1000.

The converting unit 1102 extracts from the units-of-storage master 230, the unit-of-storage information 600-1, 600-2 corresponding to the identified category “tomato”, cropping model “summer sowing cultivation”, and unit of storage “container” of the crop. The converting unit 1102 identifies among the extracted unit-of-storage information 600-1, 600-2, the unit-of-storage information that includes the harvest date or the planned harvest period of the crop in an applicable period.

In this example, among the unit-of-storage information 600-1, 600-2, the converting unit 1102 identifies the unit-of-storage information 600-2, which includes the planned harvest period “February 05 to February 28” in the applicable period. The converting unit 1102 refers to the identified unit-of-storage information 600-2 and identifies the kg-conversion value “9.0”. As a result, the kg-conversion value corresponding to the category, the cropping model, the harvest period, and the unit of storage of the crop may be identified.

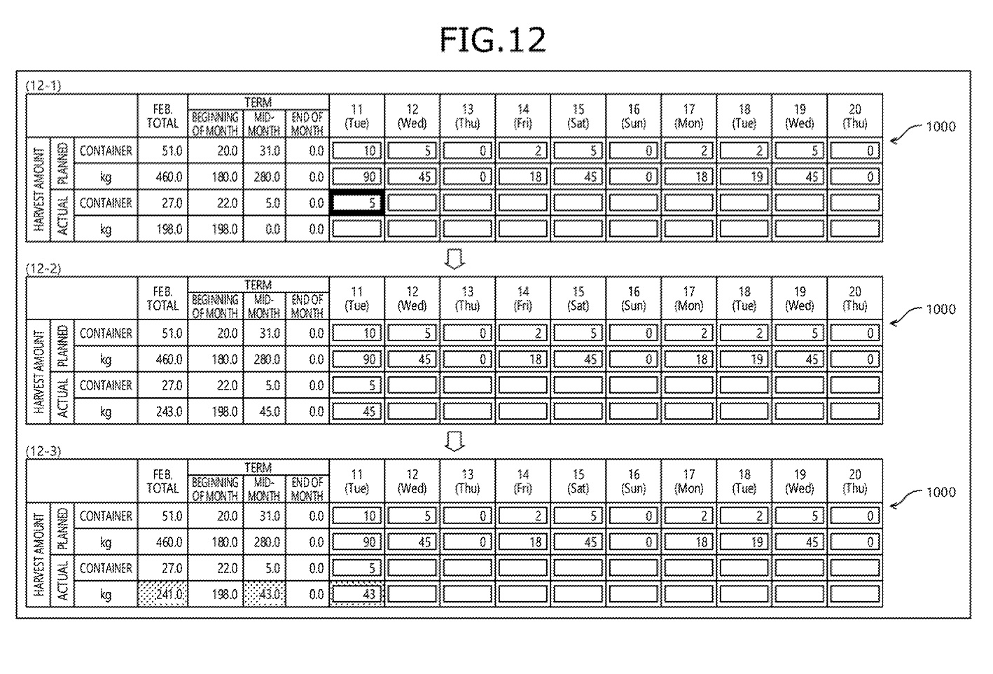

The converting unit 1102 uses a conversion ratio indicated by the identified kg-conversion value to convert the input value indicating the harvest amount by a unit of storage into a weight value. As a result, with consideration of the density, which varies consequent to differences in the category, the cropping model, and the planned harvest period of crops, values indicating the harvest amount by a unit of storage may be converted to corresponding weight values. An example of converting a value indicating the harvest amount by a unit of storage into a weight value will be described with reference to FIG. 12.

The display control unit 1103 displays input values indicating harvest amounts by a unit of storage, and weight values obtained by conversion. For example, the display control unit 1103 performs control to display the values indicating the harvest amounts by a unit of storage and the weight values obtained by conversion on the display 406 of the client apparatus 201.

For example, the display control unit 1103 generates and transmits to the client apparatus 201, screen information of a harvest amount registration screen (for example, the harvest amount registration screen 1000 depicted in FIG. 12 described hereinafter) that associates and displays the value indicating the harvest amount by a unit of storage and the weight value obtained by conversion.

Changing of a value indicating the harvest amount by a unit of storage will be described. The receiving unit 1101 receives among displayed values, a change of a value indicating the harvest amount by a unit of storage. A change of a value indicating the harvest amount by a unit of storage, for example, is performed in the harvest amount registration screen 1000 by user input operation of the client apparatus 201. The client apparatus 201 transmits to the harvest amount display apparatus 100, a change result for the change performed for the value indicating the harvest amount by a unit of storage.

In this case, the receiving unit 1101 receives the change result from the client apparatus 201 and thereby, receives the change of the value indicating the harvest amount by a unit of storage. A change of a value indicating the harvest amount by a unit of storage, for example, may be performed when the user of the client apparatus 201 errantly inputs a value indicating the harvest amount by a unit of storage.

The converting unit 1102, when a value indicating the harvest amount by a unit of storage has been changed, converts the changed value indicating the harvest amount by a unit of storage into a corresponding weight value. For example, the converting unit 1102 uses a conversion ratio identified from the units-of-storage master 230 to convert the changed value indicating the harvest amount by a unit of storage into a weight value.

When a value indicating the harvest amount by a unit of storage is changed among displayed values, the display control unit 1103 changes the weight value to a weight value obtained by converting the changed value indicating the harvest amount by a unit of storage. For example, the display control unit 1103 displays on the display 406 of the client apparatus 201, the changed value indicating the harvest amount by a unit of storage and the weight value obtained by converting the changed value indicating the harvest amount by a unit of storage.

A change of a value indicating a harvest amount by a unit of weight will be described. The receiving unit 1101, among displayed value, receives a change of a weight value. A change of a weight value, for example, is performed in the harvest amount registration screen 1000 by user input operation of the client apparatus 201. The client apparatus 201 transmits a change result performed for a weight value to the harvest amount display apparatus 100.

In this case, the receiving unit 1101 receives the change result from the client apparatus 201 and thereby, receives the change of the weight value. A change of a weight value, for example, may be performed at the time of sorting or shipping, when a weight value obtained by converting a value indicating the harvest amount by a unit of storage is corrected to a correct value.

The converting unit 1102, when a weight value has been changed, does not convert the input value indicating the harvest amount in a unit of storage. In other words, even when a value indicating a harvest amount by a unit of weight is changed, the converting unit 1102 does not convert the changed value indicating the harvest amount by a unit of weight into a corresponding value indicating the harvest amount by a unit of storage.

The display control unit 1103, when a weight value has been changed among displayed values, does not change the input value indicating the harvest amount by a unit of storage. As a result, even when a value indicating a harvest amount by a unit of weight is corrected, the value indicating the harvest amount by a unit of storage and used for evaluating the work performance of the worker who performed the harvesting operations may be prevented from being changed.

Input of a value indicating a harvest amount by a unit of weight will be described. The receiving unit 1101 receives input of a value indicating the harvest amount of a certain crop by a unit of weight, i.e., a weight value of the harvest amount. The weight value of the harvest amount of the certain crop, for example, is input to the harvest amount registration screen 1000 by user input operation of the client apparatus 201. The user, for example, is a worker who performed the harvesting operations of the crop, a farm manager managing the workers.

The client apparatus 201 transmits to the harvest amount display apparatus 100, an input result of the input weight value of the harvest amount. In this case, the receiving unit 1101 receives the input result from the client apparatus 201 and thereby, receives the input of the weight value of the harvest amount of the certain crop.

The converting unit 1102 may be configured such that, when a weight value has been input, the converting unit 1102 does not perform conversion into a value indicating the harvest amount by a unit of storage corresponding to the input weight value. In other words, when a weight value has been input as the harvest amount of the crop before a value indicating the harvest amount by a unit of storage, the converting unit 1102 may be configured so as to not perform conversion to a value indicating the harvest amount by a unit of storage corresponding to the weight value.

The display control unit 1103, when a weight value has been input, displays the input weight value. Here, the display control unit 1103 may be configured so that, when a value indicating the harvest amount by a unit of storage has not been input before a weight value, a value indicating the harvest amount by a unit of storage is not displayed.

For example, when conversion to a value indicating the harvest amount by a unit of storage corresponding to the input weight value is not performed, the display control unit 1103 does not display a value indicating the harvest amount by a unit of storage. Further, the display control unit 1103, even when the input weight value has been converted into a value indicating the harvest amount by a unit of storage, does not display the value obtained by conversion.

As a result, when the correct weight of the harvested crop is known and a weight value has been input as the harvest amount of the crop before a value indicating the harvest amount by a unit of storage, the display of a value indicating the harvest amount by a unit of storage converted from the input weight value may be prevented.

The converting unit 1102, when a value indicating the harvest amount by a unit of storage has been input, may determine whether a corresponding weight value has been input. The converting unit 1102 may be configured such that when a weight value has been input, conversion to a weight value corresponding to the input value indicating the harvest amount by a unit of storage is not performed.

Input of a weight value, as a harvest amount of a crop, before a value indicating the harvest amount by a unit of storage may be a case where the correct weight of the harvested crop is known. Therefore, by not performing conversion to a weight value corresponding to the input value indicating the harvest amount by a unit of storage when a value indicating the harvest amount by a unit of storage is input after input of the weight value, a correct weight of the harvested crop may be prevented from being changed.

However, when a weight value obtained by converting the input value indicating the harvest amount by a unit of storage is displayed and a new value indicating the harvest amount by a unit of storage is input, the converting unit 1102 converts the newly input value indicating the harvest amount by a unit of storage into a corresponding weight value.

The converting unit 1102, when a value indicating the harvest amount by a unit of storage has been changed, may determine whether a corresponding weight value has been input. The converting unit 110 may be configured such that, when a weight value has been input, conversion to a weight value corresponding to the changed value indicating the harvest amount by a unit of storage is not performed.

An example of screen change of the harvest amount registration screen 1000 will be described taking the harvest amount registration screen 1000 depicted in FIG. 10 as an example.

FIG. 12 is a diagram of a screen change example of the harvest amount registration screen 1000. Here, a screen change example of the harvest amount registration screen 1000 in a case where a value indicating the harvest amount of a crop by a unit of storage has been input will be described. In FIG. 12, a portion of the harvest amount registration screen 1000 is displayed.

(12-1) In the harvest amount registration screen 1000, a value “5” indicating the actual harvest amount on February 11 (Tue.) in units of containers is input by user input operation. In this case, the receiving unit 1101 receives input of the value “5” indicating the actual harvest amount in units of containers. The converting unit 1102 refers to the units-of-storage master 230 and identifies a kg-conversion value corresponding to the category, the cropping model, the harvest period, and the unit of storage of the crop.

Here, the kg-conversion value “9.0” is identified. In this case, the converting unit 1102 multiplies the input value “5” indicating the actual harvest amount in units of containers by the kg-conversion value “9.0” and thereby, calculates a value “45” indicating the actual harvest amount in units of kg. The display control unit 1103 displays the value “5” indicating the actual harvest amount in units of containers and the value “45” indicating the actual harvest amount in units of kg associated with each other.

(12-2) In the harvest amount registration screen 1000, the value “5” indicating the actual harvest amount in units of containers and the value “45” indicating the actual harvest amount in units of kg for February 11 (Tue.) are displayed associated with each other. As a result, the user of the client apparatus 201 may know the weight (45 kg) of the harvested crop corresponding to the input value “5” indicating the harvest amount in units of containers.

Here, at the time of shipping of the harvested crop, the actual measured weight of the harvested crop is assumed to be 43 kg. In this case, the user the client apparatus 201 corrects the weight value “45” obtained by conversion of the input value “5” indicating the harvest amount in units of containers.

(12-3) In the harvest amount registration screen 1000, the actual harvest amount for February 11 (Tue.) is changed to a value “43” indicating the actual harvest amount in units of kg by user input operation. In this case, the receiving unit 1101 receives the change of the value indicating the actual harvest amount in units of kg. Here, the converting unit 1102 does not convert the input value “5” indicating the harvest amount in units of containers.

The display control unit 1103, even when the value indicating the harvest amount in units of kg has been changed, does not change the input value “5” indicating the harvest amount in units of containers. As a result, the value “5” indicating the actual harvest amount in units of containers and used to evaluate the work performance of the worker who performed the harvesting operations may be prevented from being changed.

When a value indicating the actual harvest amount in units of kg has been changed, the harvest amount display apparatus 100 changes based on the changed value, the actual harvest amount for the month indicated in units of kg. The harvest amount display apparatus 100 further changes based on the changed value, the actual harvest amount indicating the harvest amount for the term (mid-month) in units of kg.

Here, the actual harvest amount for the month and indicated in units of kg is changed to “241.0”. Further, the actual harvest amount for the term (mid-month) and indicated in units of kg is changed to “43.0”. Here, the harvest amount display apparatus 100 may perform control to display with emphasis the changed actual harvest amount for the month “241.0”, the changed actual harvest amount for the term (mid-month) “43.0”, and the changed actual harvest amount for February 11 (Tue.) “43”.

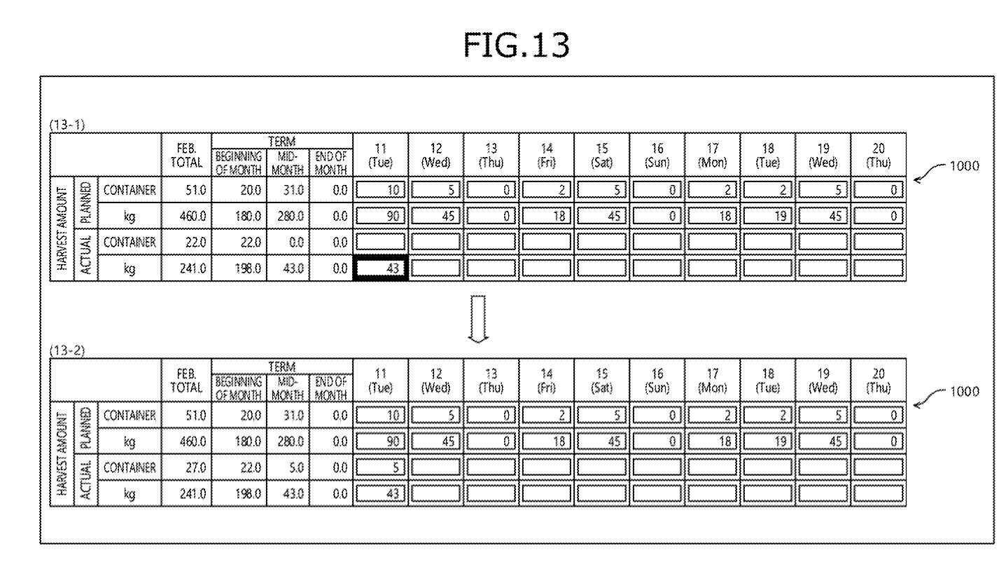

FIG. 13 is a diagram of a screen change example of the harvest amount registration screen 1000. Here, a screen change example of the harvest amount registration screen 1000 in a case where a weight value is input, as a harvest amount of a crop, before a value indicating the harvest amount by a unit of storage will be described. In FIG. 13, a portion of the harvest amount registration screen 1000 is displayed.

(13-1) In the harvest amount registration screen 1000, the value “43” indicating the actual harvest amount for February 11 (Tue.) in units of kg is input by user input operation. In this case, the receiving unit 1101 receives the input of the value “43” indicating the actual harvest amount in units of kg. Here, the converting unit 1102 does not perform conversion to a value indicating the actual harvest amount in units of containers corresponding to the value indicating the actual harvest amount in units of kg.

The display control unit 1103 displays the value “43” indicating the harvest amount in units of kg. Here, the display control unit 1103 does not display a value indicating the actual harvest amount in units of containers since conversion to a value indicating the actual harvest amount in units of containers corresponding to the input value indicating the actual harvest amount in units of kg is not performed.

(13-2) In the harvest amount registration screen 1000, the value “5” indicating the actual harvest amount for February 11 (Tue.) in units of containers is input by user input operation. The receiving unit 1101 receives the input of the value “5” indicating the actual harvest amount in units of containers. The converting unit 1102 determines whether a weight value corresponding to the input value “5” indicating the actual harvest amount in units of containers has been input.

Here, a value “43” indicating the harvest amount in units of kg has been input before the value “5” indicating the actual harvest amount in units of containers. Therefore, the converting unit 1102 determines that a weight value corresponding to the input value “5” indicating the actual harvest amount in units of containers has been input. In this case, the converting unit 1102 does not perform conversion to a value indicating the actual harvest value in units of kg corresponding to the input value “5” indicating the actual harvest amount in units of containers.

The display control unit 1103 displays the input value “5” indicating the actual harvest amount in units of containers. Here, the display control unit 1103 does not change the displayed value “43” indicating the harvest amount in units of kg since conversion to a value indicating the actual harvest value in units of kg corresponding to the input value “5” indicating the actual harvest amount in units of containers is not performed.

In this manner, when a value indicating the harvest amount in units of containers is input after a value indicating the harvest amount of the crop in units of kg has been input, conversion to a weight value corresponding to the input value indicating the harvest amount in units of containers is not performed, whereby the correct weight of the harvested crop may be prevented from being changed.

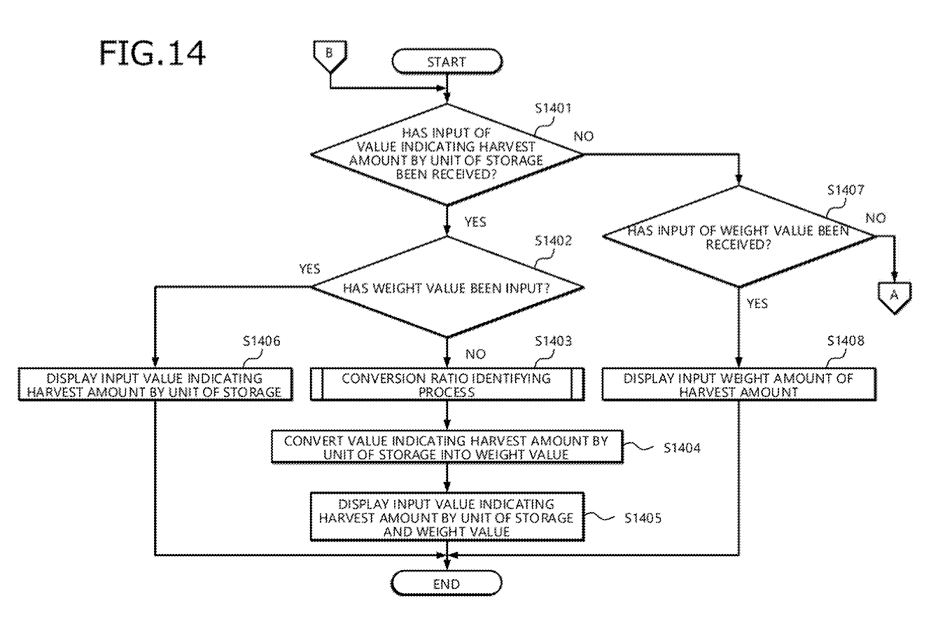

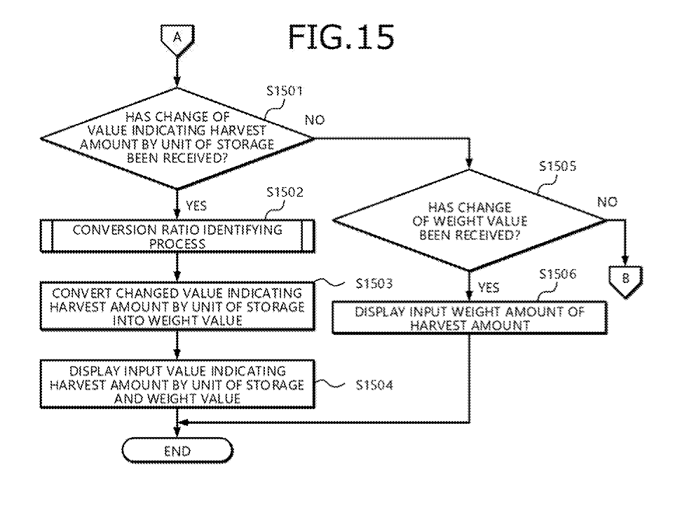

FIGS. 14 and 15 are flowcharts of a procedure of a harvest amount display process of the harvest amount display apparatus 100. In the flowchart depicted in FIG. 14, the harvest amount display apparatus 100 determines whether input of a value indicating the harvest amount of a certain crop by a unit of storage has been received (step S1401).

If input of a value indicating the harvest amount by a unit of storage has been received (step S1401: YES), the harvest amount display apparatus 100 determines whether a weight value corresponding to the input value indicating the harvest amount by a unit of storage has been input (step S1402).

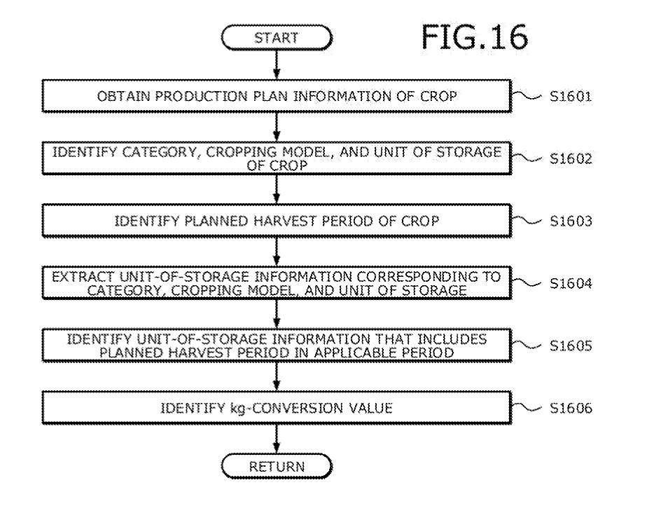

If no weight value has been input (step S1402: NO), the harvest amount display apparatus 100 executes a conversion ratio identifying process (step S1403). The conversion ratio identifying process is a process of identifying a conversion ratio for converting a value indicating the harvest amount by a unit of storage into a weight value. Details of the conversion ratio identifying process will be described with reference to FIG. 16.

The harvest amount display apparatus 100 uses a conversion ratio indicated by a kg-conversion value identified by the conversion ratio identifying process and converts the input value indicating the harvest amount by a unit of storage into a weight value (step S1404). The harvest amount display apparatus 100 displays the input value indicating the harvest amount by a unit of storage and the weight value obtained by conversion, associated with each other (step S1405), and ends a series of operations according to the present flowchart.

At step S1402, if a weight value has been input (step S1402: YES), the harvest amount display apparatus 100 associates and displays the input value indicating the harvest amount by a unit of storage with the input weight value (step S1406), and ends a series of operations according to the flowchart.

At step S1401, if input of a value indicating the harvest amount by a unit of storage has not been received (step S1401: NO), the harvest amount display apparatus 100 determines whether input of a weight value of the harvest amount of the certain crop has been received (step S1407).

Here, if input of a weight value of the harvest amount has been received (step S1407: YES), the harvest amount display apparatus 100 displays the input weight amount of the harvest amount (step S1408), and ends a series of operations according to the flowchart. As step S1407, if no input of a weight value of the harvest amount has been received (step S1407: NO), the harvest amount display apparatus 100 transitions to step S1501 depicted in FIG. 15.

In the flowchart depicted in FIG. 15, the harvest amount display apparatus 100 determines whether a change of a value indicating the harvest amount of the crop by a unit of storage has been received (step S1501). If a change of a value indicating the harvest amount by a unit of storage has been received (step S1501: YES), the harvest amount display apparatus 100 executes the conversion ratio identifying process (step S1502).

The harvest amount display apparatus 100 uses a conversion ratio indicated by a kg-conversion value identified by the conversion ratio identifying process and converts the changed value indicating the harvest amount by a unit of storage into a weight value (step S1503). The harvest amount display apparatus 100 displays the changed value indicating the harvest amount by a unit of storage and the weight value obtained by conversion, associated with each other (step S1504), and ends a series of operations according to the flowchart.

At step S1501, if no change of a value indicating the harvest amount by a unit of storage has been received (step S1501: NO), the harvest amount display apparatus 100 determines whether a change of a weight value of the harvest amount of the crop has been received (step S1505). If no change of a weight value has been received (step S1505: NO), the harvest amount display apparatus 100 returns to step S1401 depicted in FIG. 14.

If a change of a weight value has been received (step S1505: YES), the harvest amount display apparatus 100 displays the changed weight value of the harvest amount (step S1506), and ends a series of operations according to the flowchart.

As a result, concerning the harvest amount of a certain crop, an input value indicating the harvest amount by a unit of storage is converted into a corresponding weight value, and the input value indicating the harvest amount by a unit of storage and the weight value obtained by conversion may be displayed. When among displayed values, a value indicating the harvest amount by a unit of storage has been changed, and when the weight value is changed to a weight value that corresponds to the changed value indicating the harvest amount by a unit of storage, and the weight value has been changed, configuration may be such that the input value indicating the harvest amount by a unit of storage is not changed.

A detailed process procedure of the conversion ratio identifying process at step S1403 in FIG. 14 and step S1502 in FIG. 15 will be described.

FIG. 16 is a flowchart of an example of details of a process procedure of the conversion ratio identifying process. In the flowchart depicted in FIG. 16, the harvest amount display apparatus 100 obtains from the production plan DB 220, production plan information of a crop (step S1601).

The harvest amount display apparatus 100 refers to the obtained production plan information and identifies the category, the cropping model, and the unit of storage of the crop (step S1602). The harvest amount display apparatus 100 refers to the obtained production plan information and identifies the planned harvest period of the crop (step S1603).

The harvest amount display apparatus 100 extracts from the units-of-storage master 230, unit-of-storage information corresponding to the category, the cropping model, and the unit of storage identified for the crop (step S1604). The harvest amount display apparatus 100, among the extracted unit-of-storage information, identifies unit-of-storage information that includes the planned harvest period of the crop in the applicable period (step S1605).

The harvest amount display apparatus 100 refers to the identified unit-of-storage information, and identifies a kg-conversion value indicated by the conversion ratio (step S1606), and returns to the step calling the conversion ratio identifying process. As a result, a kg-conversion value corresponding to the category, the cropping model, the harvest period, and the unit of storage of the crop may be identified.

As described, the harvest amount display apparatus 100 according to the embodiment enables input of a value indicating the harvest amount of a certain crop by a unit of storage to be received and the input value indicating the harvest amount by a unit of storage to be converted into a corresponding weight value. The harvest amount display apparatus 100 enables the input value indicating the harvest amount by a unit of storage and the weight value obtained by conversion to be displayed associated with each other on the display 406 of the client apparatus 201.

As a result, without actually measuring the weight of harvested crop, based on a weight value obtained by converting a value indicating the harvest amount by a unit of storage such as a container or box used in harvesting operations, the harvest amount of a crop may be identified by a unit of weight such as kg, enabling the harvest amount and yield to be evaluated.

The harvest amount display apparatus 100 enables, when among displayed values, a value indicating the harvest amount by a unit of storage has been changed, and when a weight value is changed to a weight value that corresponds to the changed value indicating the harvest amount by a unit of storage and the weight value has been changed, the input value indicating the harvest amount by a unit of storage to not be changed.

As a result, when the weight of the harvest amount is corrected at the time of sorting or shipping, the count of boxes or containers for evaluating the work performance of the worker may be prevented from being changed corresponding to the correction of the weight, enabling an inability to correctly evaluate the work performance of the worker to be prevented.

The harvest amount display apparatus 100 enables, when input of a weight value of the harvest amount of a certain crop is received, the input weight value to be displayed; and conversion to value indicating the harvest amount by a unit of storage corresponding to the input weight value to not be performed or a value obtained by converting the input weight value to not be displayed.

As a result, when the correct weight of the harvested crop is known and a weight value is input as the harvest amount of the crop before a value indicating the harvest amount by a unit of storage, display of a value indicating the harvest amount by a unit of storage and converted from the input weight value may be prevented. As a result, an inability to correctly evaluate the work performance of a worker not simply proportional to the weight of the harvest crop may be prevented.

The harvest amount display apparatus 100 enables, when an input value indicating the harvest amount by a unit of storage is converted to a corresponding weight value, identification of a conversion ratio of the crop and corresponding to the unit of storage for any one of the cropping model of the crop, the harvest date of the crop, and the planned harvest period of the crop. The harvest amount display apparatus 100 enables the input value indicating the harvest amount by a unit of storage to be converted to a weight value by the identified conversion ratio.

As a result, a value indicating the harvest amount by a unit of storage may be converted into a corresponding weight value with consideration of density, which varies consequent to differences in the categories, cropping models, and harvest periods of crops, for example, the specific gravity of the crop according to season.

The harvest amount display apparatus 100 enables, when input of a value indicating the harvest amount by a unit of storage has been received, determination of whether input of a corresponding weight value has been received. The harvest amount display apparatus 100 enables, when a weight value has been input, a value indicating the harvest amount by a unit of storage to be displayed, and conversion to a weight value corresponding to the value indicating the harvest amount by a unit of storage to not be performed or the weight value obtained by converting the value indicating the harvest amount by a unit of storage to not be displayed.

As a result, when the correct weight of the harvested crop is known and a value indicating the harvest amount by a unit of storage is input as the harvest amount of the crop after the weight value has been input, the correct weight of the harvest crop may be prevented from being changed by conversion to a weight value corresponding to the input value indicating the harvest amount by a unit of storage.

The harvest amount display method described in the present embodiment may be implemented by executing a prepared program on a computer such as a personal computer and a workstation. The program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

According to conventional techniques, the weight of harvested crop that fits into a single container or box used in harvesting operations of the crop varies according to how the worker puts the crop in the receptacle, the specific gravity of the crop dependent on season, and the like. Therefore, although the weight obtained by converting a count of the containers or boxes may be corrected, if the count of containers or boxes is changed corresponding to the correction of the weight, work performance of the worker may not be correctly evaluated.

According to one aspect of the present invention, an effect is achieved in that proper management of work performance of workers with respect to the harvest amount of a crop is possible.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A harvest amount display method comprising:
receiving, by a computer, input of a first value indicating a harvest amount of a predetermined crop by a unit of storage;
converting, by the computer, the input first value into a second value indicating a corresponding weight;
displaying, by the computer, the first value and the second value obtained by conversion; and
controlling the display, by the computer, when among displayed values, the first value is changed, controlling to change the displayed second value to a third value indicating a weight corresponding to the changed first value, controlling not to change the displayed first value, when among the displayed values, the second value is changed.

2. A harvest amount display method comprising:
receiving, by a computer, input of a harvest amount of a predetermined crop by any one of a first value indicating the harvest amount by a unit of storage and a second value indicating the harvest amount by weight; and
displaying, by the computer when the input of the first value is received, the first value and a third value obtained by converting to a weight corresponding to the input first value, and when the input of the second value is received, displaying the input second value, and not converting to a fourth value indicating the harvest amount by a unit of storage corresponding to the input second value or not displaying the fourth value.

3. The harvest amount display method according to claim 1, wherein
the converting the input first value to the third value includes converting to a unit of weight by a conversion ratio identified corresponding to any one of a cropping model of the crop, a harvest date identified based on the crop, and a planned harvest period recorded associated with the crop.

4. The harvest amount display method according to claim 2, further comprising:
determining, by the computer when the input of the first value is received, whether a corresponding value indicating the harvest amount by weight is input, wherein
the displaying includes, when the second value is input, displaying the first value and not converting to the third value or not displaying the third value.

5. A conversion method comprising:
receiving, by a computer, a harvest amount of a predetermined crop, by a first value indicating the harvest amount by a unit of storage;
converting, by the computer, the input first value by a conversion rule corresponding to any one of a cropping model of the crop, a harvest date identified based on the crop, and a planned harvest period recorded associated with the crop; and
outputting, by the computer, a second value obtained by the converting.

6. The conversion method according to claim 5, wherein the second value is a value of a unit of weight.

7. A system comprising:
a client apparatus connected to a display; and
a harvest amount display apparatus that includes a memory and a processor coupled to the memory, the processor configured to:
receive from client apparatus, input of a first value indicating a harvest amount of a predetermined crop by a unit of storage;
convert the input first value into a second value indicating a corresponding weight;
display on the display, the first value and the second value; and
controlling the display, when among displayed values, the first value is changed, the controlling to change the displayed second value to a third value indicating a weight corresponding to the changed first value, controlling not to change the displayed first value, when among the displayed values, the second value is changed.

8. A system comprising:
a client apparatus connected to a display; and
a harvest amount display apparatus including a memory and a processor coupled to the memory, the processor configured to:
receive from the client apparatus, input of a harvest amount of a predetermined crop by any one of a first value indicating the harvest amount by a unit of storage and a second value indicating the harvest amount by weight; and
display, on the display when the input of the first value is received, the first value and a third value obtained by converting to a weight corresponding to the input first value; and when the input of the second value is received, displaying on the display, the input second value, and not converting to a fourth value indicating the harvest amount by a unit of storage corresponding to the input second value or not displaying on the display, the fourth value.

9. The harvest amount display method according to claim 2, wherein
the converting the input first value to the third value includes converting to a unit of weight by a conversion ratio identified corresponding to any one of a cropping model of the crop, a harvest date identified based on the crop, and a planned harvest period recorded associated with the crop.
